(19) United States
(12) Patent Application Publication
(10) Pub. No.: US 2010/0281835 A1
(43) Pub. Date: Nov. 11, 2010

(54) Harvester Head With Adhesive Attached Back Sheet

(76) Inventors: Akhil Rajendra Tipnis, Bettendorf, IA (US); Steven Timothy Rieck, Cambridge, IL (US)

Correspondence Address: DEERE & COMPANY, ONE JOHN DEERE PLACE, MOLINE, IL, 61265, US

(21) Appl. No.: 12/463,658

(22) Filed: May 11, 2009

(51) Int. Cl. A01D 67/00; B23P 11/00

(52) U.S. Cl. 56/1; 29/428

(57) ABSTRACT

A harvester head (14) comprising at least first, and second panels (28, 30) of sheet metal that are disposed to direct a lateral flow of outcrop material toward, a feederhouse (18), and an adhesive layer (52) that fixes the first and second panels together.

### FIELD OF THE INVENTION

The invention relates to agricultural equipment. More particularly, it relates to harvesting equipment. Even more particularly, it relates to harvester heads for gathering crop that are supported on feederhouses of combine vehicles and extend laterally with respect to the direction of travel through the agricultural field.

### BACKGROUND OF THE INVENTION

In recent years, harvester heads for combine vehicles have been designed with increasing widths. By increasing the width they are capable of harvesting a wider swath of cereal crops or more rows of maize. As the harvester heads get wider, their weight increases exponentially. The harvester head is supported on the feederhouse and therefore its rotational inertia about the feederhouse increases as the length of the harvester head increases.

In one common form, harvester heads of agricultural harvesters are constructed from one or more laterally extending structural seams and associated linking members that form a framework. Attached to these beams and linking members are thin sheets of metal that form the working surfaces which contain the cut crop material. These working surfaces, formed of elongate panels of sheet metal, are not used primarily to provide substantial strength and rigidity to the harvester head, but to support the crop material as it is moved by the auger from each row unit to the entrance of the feederhouse. Since they only support the weight of the cut crop material they do not need to be heavy. They can be made very thin and light and still function well.

It is difficult to secure thin panels to each other. In the prior art, the panels are typically weeded or bolted to the framework of the harvester head and to each other. As the thickness of the panels forming the working surfaces is reduced, the stress concentrations around the fastening points can become quite large. Further, it is difficult to weld thin materials. The thermal cycling caused by welding can cause the panels to warp as they, are welded or thereafter, thereby providing a rippled, twisted, bent, dimpled, or other irregular or unsightly surface.

What is needed are methods of assembling the harvester head including, aligning its component parts and securing them together. What is also needed are methods of adhesively securing the working surfaces to each other and to the framework of a harvester head. What is also needed is a harvester head that is manufactured according to one or more of these methods.

It is an object to provide such methods and harvester heads. Several inventions are described herein. These inventions are directed to solving these problems or are additionally and are necessarily disclosed to satisfy the statutory “best mode” requirement.

### SUMMARY OF THE INVENTION

In accordance with a first invention, a harvester head is provided comprising a framework to which panels defining working surfaces and formed of sheet metal are attached with an adhesive.

In accordance with a second invention, a method is provided of constructing a harvester head by providing a tab and slot arrangement on at least two panels that working surfaces for conveying cut crop material to self align the two panels. The means of fastening the panels together is preferably an adhesive, although it may be weldment or removable fasteners.

In accordance with a third invention, a method of holding two working surfaces of a harvester head in proper aligned engagement with each other by providing interengaging structures along edges of the two working surfaces that support the two working surfaces in predetermined alignment in preparation of adhering them together. These interengaging structures may include a tab and slot arrangement. They may include other arrangements, that, like some tab and slot arrangements, limit the relative movement of the 2 panels to rotation about a longitudinal axis. They may include an arrangement like a tab and slot arrangement that converts unidirectional tension applied to at least one of the panels in at least one position into a compression force that forces multiple adhesion joints into greater compression.

In accordance with a fourth invention, a first transversely extending working surface of a harvester head is provided, the first transversely extending working surface having a transversely extending upper surface portion configured to be mechanically adhered to a framework of the harvester head and a second transversely extending lower surface portion configured to be mechanically adhered to a second transversely extending working surface of the harvester head.

### BRIEF DESCRIPTION OF THE DRAWINGS

FIG. 1 is a perspective view of an agricultural harvester in accordance with the present invention.

FIG. 2 is a cross-sectional view of the harvester head of FIG. 1 taken at section line A-A in FIG. 1 with the points, covers, auger tube, and row units removed.

FIG. 3 is a perspective view of the cross-section of FIG. 2.

FIG. 4 is a fragmentary perspective view illustrating a portion of the first elongate beam of the harvester head, the back sheet, and the auger trough.

FIGS. 5A-5C are a sequence of three side views illustrating the process of assembling the back sheet and the auger trough.

### DETAILED DESCRIPTION OF THE INVENTIONS

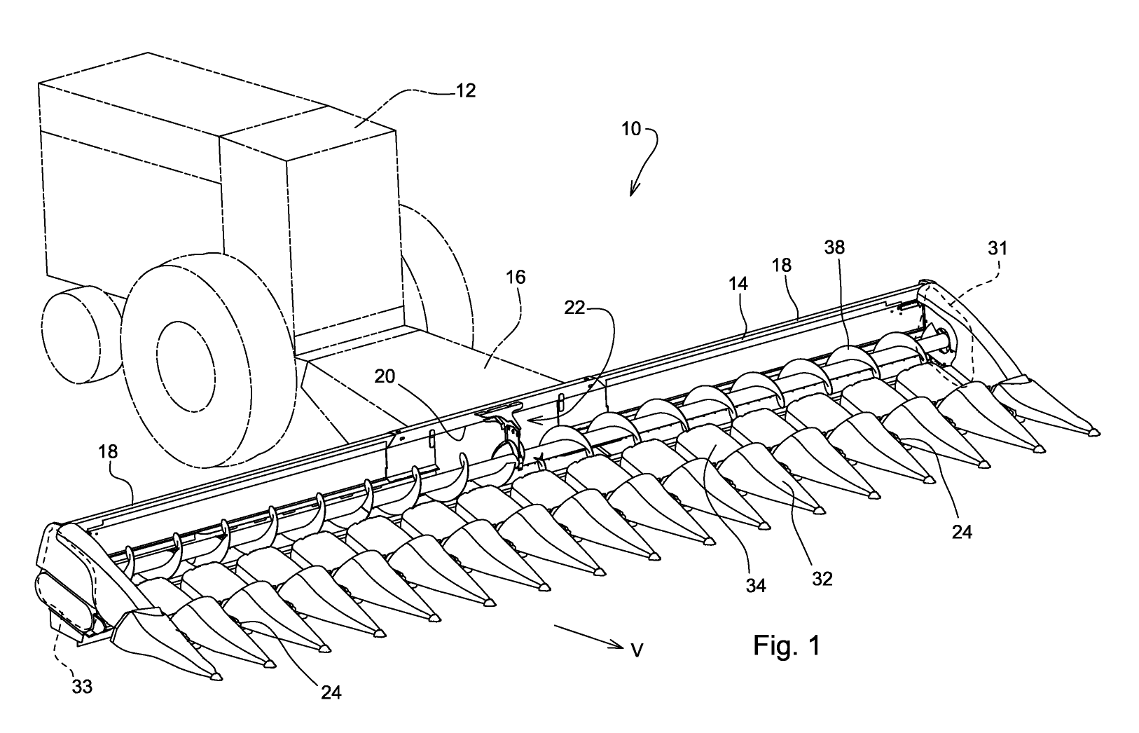

In FIG. 1, an agricultural harvester 10 comprises a serf-propelled vehicle 12 and a harvester head 14 supported on the self-propelled vehicle 12. The self-propelled vehicle 12 includes conventional means for threshing crop material, separating grain from the crop material, and cleaning the grain, which is not illustrated herein, but which is well known in the art.

The self-propelled vehicle 12 supports the harvester head 14 on a feederhouse 16 mounted on the front of the self-propelled vehicle 12. The members extend forward form the feederhouse 16 into a central aperture 22 of the feederhouse 16. A lower surface of first elongate beam 18 defines the top edge 20 of this central aperture 22. A portion of the feederhouse 18 extends into the central aperture 22. Harvester head 14 is supported on this portion of the feederhouse.

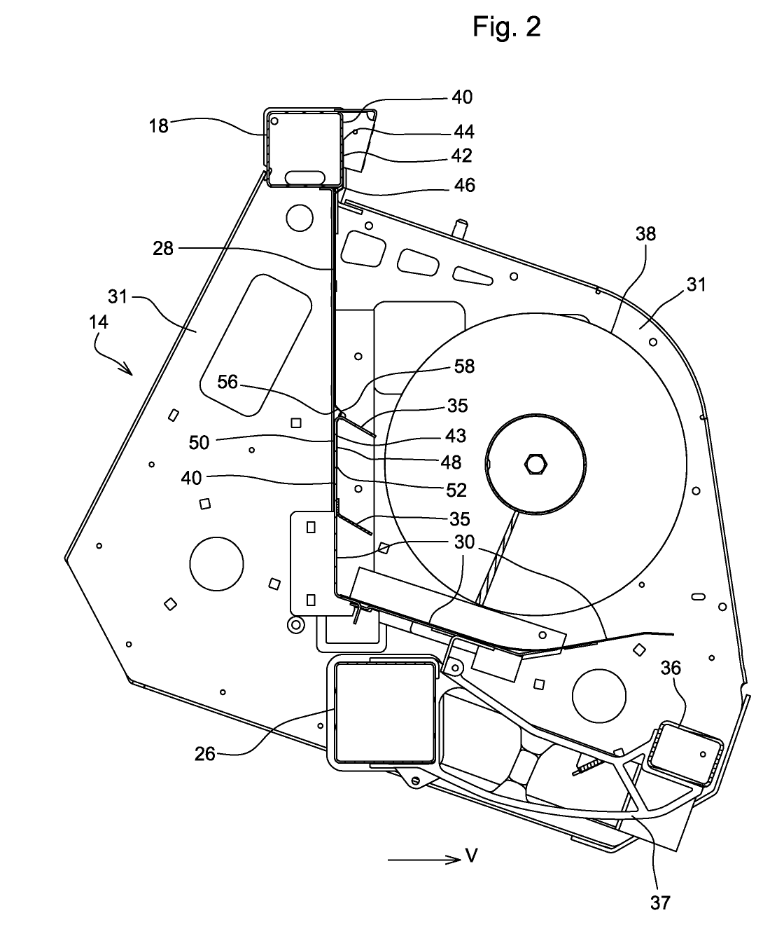

The harvester head 14 has a plurality of row units 24 (12 in the illustrated embodiment) that are disposed transversely across a leading edge of the harvester head 14 and are fixed to a toolbar 36 (better shown in FIG. 2). The row units 24 are shielded with points 32 and covers 34. The points 32 serve to separate adjacent rows of plants and direct the plants into the inlet of the row units 24. The covers 34 cover the rear portions of the row units 24 and prevent plant matter from jamming the row units 24. The harvester head 14 extends transversely (i.e. perpendicularly) to the direction of travel “V” of the agricultural harvester 10. End walls 31, 33 are disposed at opposing transverse ends of the harvester head. A transverse conveyor, here shown as auger 38, extends transversely across substantially the entire width of the harvester head, it conveys cut crop material from the row units 24 to the central aperture 22. When received in the central aperture 22, the cut crop material is conveyed by a conveyor disposed in feederhouse 16 into the self-propelled vehicle 12 where it is threshed, separated, and cleaned.

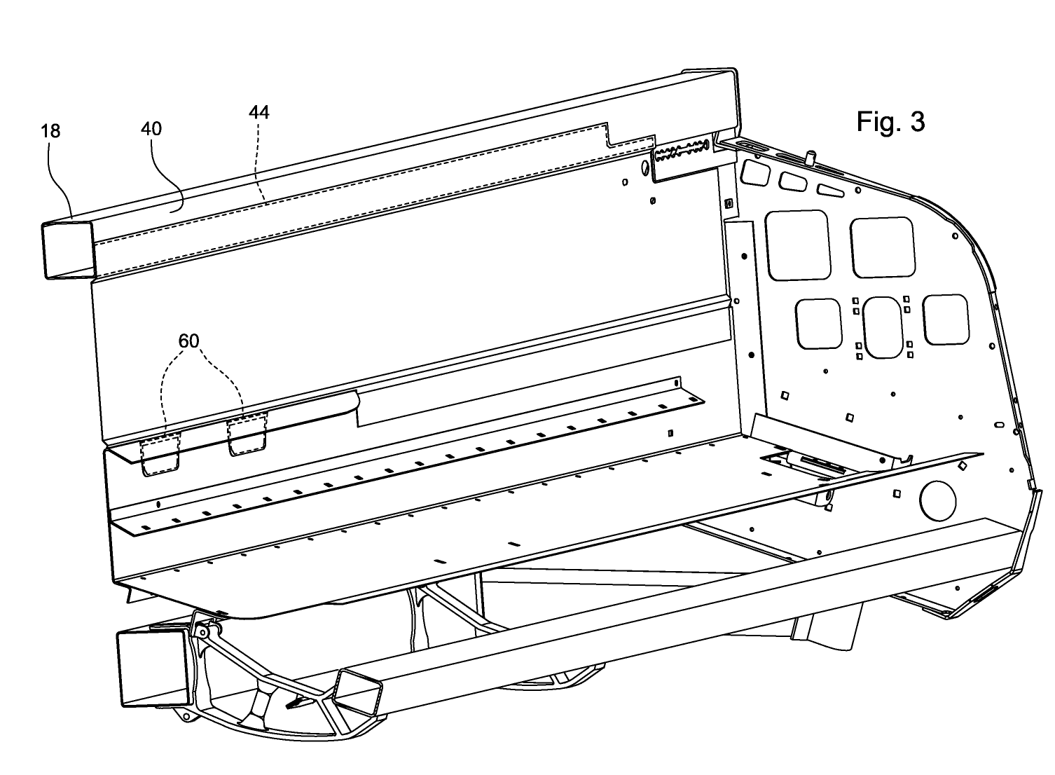

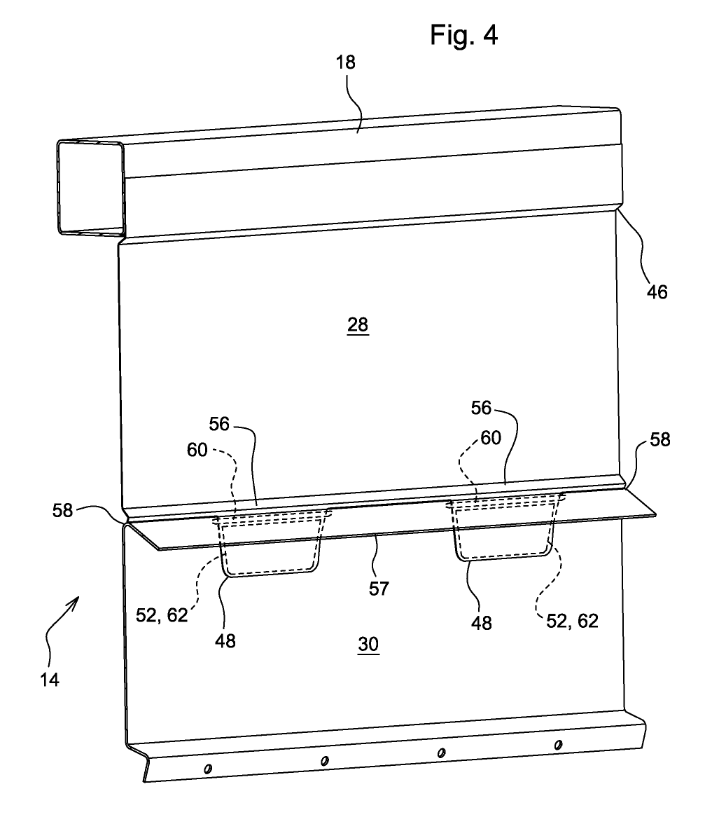

Referring now to FIGS. 3 and 4, the harvester head 14 comprises a framework which comprises the first elongate beam 18, a second elongate beam 26, a toolbar 36 toolbar supports 37, and two end wails 31, 33. This framework supports a back sheet 28 and a conveyor floor, here shown as an auger trough 30, as well as row units 24 (shown in FIG. 1).

The end walls 31, 33 (33 is shown in FIG. 1) are fixed to the first elongate beam 18 and to the second elongate beam 26. They are disposed at opposite transverse ends of the harvester head 14.

The first elongate beam 18, second elongate beam 26, and toolbar 36 are disposed horizontally and parallel to each other. They extend transversely, i.e. perpendicular to the direction of travel “V” of the agricultural harvester 10, with the second elongate beam 26 disposed below the auger trough 30 and back sheet 28. Toolbar 36 is supported on second elongate beam 26 by a plurality of toolbar supports 37 that are cantilevered forward from their mounting point oh second elongate beam 26. Row units 24 (not shown) are mounted to toolbar 38 and extend forward in the direction of travel “V” from toolbar 36.

The auger trough 30 and the back sheet 28 are fixed together and to the first elongate beam 18 to form a continuous sheet extending from the first elongate beam 18 downward and behind auger 38, and then forward to the rear edge of the row-units (not shown).

The auger trough 30 and back sheet 28 are generally planar sheet members or panels that are provided to support the crop material as it is carried by the auger 38 from the row units 24 to the central aperture 22. They are disposed adjacent the auger 38 on 2 sides—the rear of auger 38 and the bottom of auger 38.

Back sheet 28 and auger trough 30 together form the working surfaces of the harvester head over which the cut crop material is dragged. The back sheet 28 prevents cut crop material from being pushed out the back of the combine as auger 38 rotates. The auger trough 30 forms a floor ever which the cut crop material is dragged thereby preventing it from failing onto the ground.

The first elongate beam 18 has a forward-facing surface 40 to which a top surface portion 42 of the back sheet 28 is adhered with an interposed layer of adhesive 44. In FIGS. 2 and 3, top surface portion 42 of the back sheet 28 extends horizontally and laterally, parallel to the longitudinal extent of the first elongate beam 18, and coplanar with forward-facing surface 40.

The bottom surface portion 43 of the back sheet 28 is adhered to an upper portion 50 of auger trough 30 by an interposed layer of adhesive 52 over substantially its entire width. In the preferred embodiment, illustrated herein, the bottom surface portion 43 is divided into a plurality of extensions 48. These extensions 48 are adhered to upper portion 50 of auger trough 30 at individual, spaced apart locations. This panel-to-panel adhesion is provided by adhesive patches 62 that together form the interposed layer of adhesive 52.

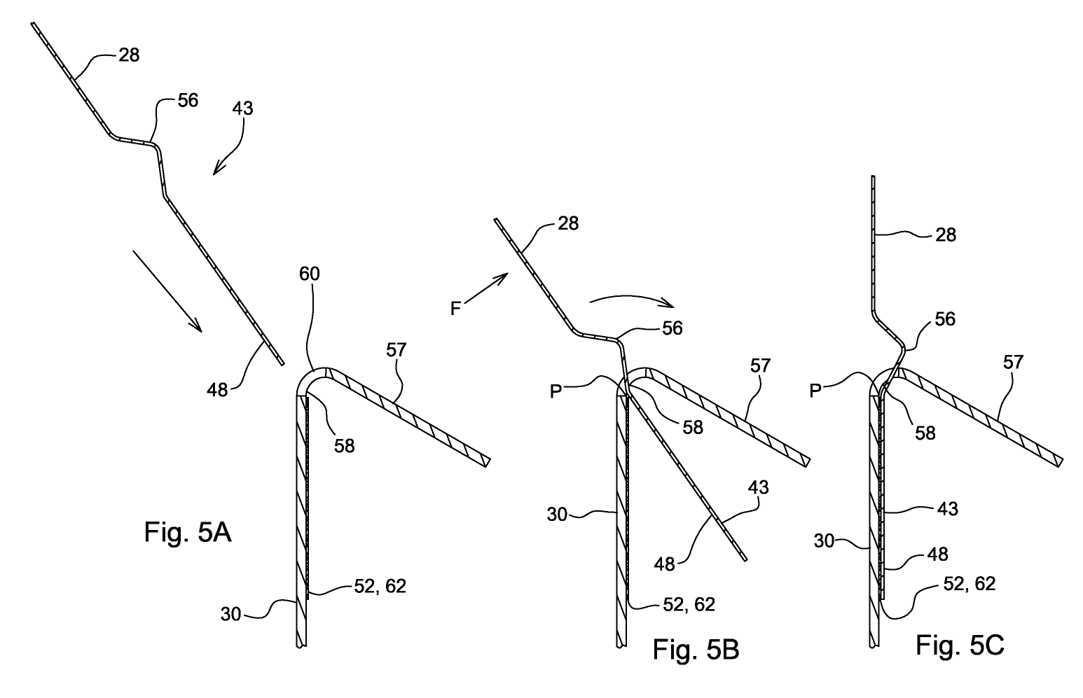

A crease 56 is provided in the back sheet just above the bottom surface portion 43 and its extensions 48. Crease 56 provides rigidity to the back sheet 28 adjacent to the extensions 48, projecting back sheet 28 into 3 dimensions to give it rigidity. This arrangements helps to ensure that back sheet 28 does not flex substantially when it is being assembled to auger trough 30, and ensures therefore that extensions 48 can be readily inserted into their corresponding slots 60 in auger trough 30. It also helps to ensure that the rotational forces later applied to rotate the back sheet 28 in auger trough 30 into their bonded position (see the sequence of FIGS. 5A-5C) are distributed over the entire layer of adhesive 52. This helps to ensure a consistent adhesive bond across the width of the harvesting head.

In another arrangement, rather than having extensions 48 disposed along the bottom edge of back sheet 28, the bottom surface portion 43 of the back sheet 28 is straight, unbroken and extends substantially the entire width of the harvester head. This bottom surface portion 43 is adhered to upper portion 50 over substantially its entire width, much as the fop surface portion 42 of back sheet 28 is adhered to forward facing surface 40 of first elongate beam 18.

The very top edge of auger trough 30 is bent forward and creased to form a stripper 57 and crease 58. Stripper 57 and crease 58 extend transversely and parallel to the longitudinal extent of first elongate beam 18, the second elongate beam 26 and crease 56 of back sheet 28. The Crease 58 that forms stripper 57 is disposed adjacent to and preferably abutting crease 56 of back sheet 28. Crease 69 is parallel to the crease 56 over substantially the entire width of the back sheet. Crease 59 abuts crease 56 over substantially the entire width of the back sheet and the auger trough.

Stripper 57 serves to prevent cut crop material from winding around auger 38 as auger 38 rotates. This helps keep the cut crop material in the lower portions of the auger trough.

FIG. 4 illustrates the interengagement of the back sheet 28 and the auger trough 30. In FIG. 4, only a short length of the first elongate beam 18, the back sheet 28, and the auger trough 30 are shown. The tabbed fragmentary portion illustrated in FIG. 4 is repeated over the entire width of the harvester head, with the exception, of course, of the central aperture region of the harvester head in which there is no back sheet 28 or upper portion of the auger trough 30.

Each of the plurality of extensions 48 has a generally rectangular tab shape. Each extension 48 is spaced apart from its adjacent extensions 48. Together, the extensions 48 extend in a line that is transverse and generally parallel to the longitudinal extent of the first elongate beam 18 and the harvesting head generally. Extensions 48 are separated from adjacent extensions 48 by a distance that is generally equal to or greater than the width of each extension.

Each extension 48 is received in a corresponding slot 60 in the upper portion of auger trough 30. Each slot 60 is oriented transversely with respect to the direction of travel and the harvesting head generally. Slots 50 are spaced apart from each other and are preferably disposed in a single line that is parallel to the longitudinal extent of the first elongate beam 18 (which also extends in the transverse direction) and parallel to the longitudinal extent of each slot 60.

Each extension 48 has a rear-facing surface portion 64 that is generally planar. This surface portion 64 of each extension 48 is adhered to an abutting forward facing surface portion 65 of the auger trough 30. Each of forward facing surface portions 65 is disposed directly below one of slots 60. An adhesive patch 62 is disposed between the two surface portions that has substantially the same area as the size of the extension to which it is bonded. This arrangement staggers the adhesive patches 62 along the lower edge of the back sheet 28 over substantially the entire width of the back sheet 28, providing a line of adhesive patches 62 between the back sheet 28 and the auger trough 30 that are substantially the same size and are spaced apart a distance generally equal to the lateral width of each adhesive joint.

In FIG. 5A-5C, a method of assembling the back sheet 28 and auger trough 30 is illustrated. In FIG. 5A, the auger trough 30 and the back sheet 28 are brought into close alignment, with the free ends of the plurality of extensions disposed adjacent, to the slots 60 in which they will be received. In FIG. 58, the back sheet 28 and the auger trough 30 are shown in a subsequent position in which each of the plurality of extensions 48 has been received in its corresponding slot 60 in the auger trough 30. In this position, the extensions 48 have been inserted into slots 60 in the auger trough 30 to their maximum depth. The bottom of the back sheet 28 between each of the plurality of extensions, abuts the upper portion of the auger trough 30 between the adjacent slots.

As shown in FIG. 5B, they abut along pivot line “P”, and are held in position by the weight of the upper one of the back sheet 28 and auger trough 30. In the picture illustrated here, back sheet 28 is shown above auger trough 30, and thus the weight of back sheet 28 would hold the extensions 48 into full engagement with slots 60 of auger trough 30. The positions could as easily be reversed, however, with the auger trough 30 superior and back sheet 28 inferior during assembly.

Once in this first predetermined relative position, shown in FIG. 5B, the upper portion of the back sheet 28 is then pivoted forward about the transversely extending line of abutting engagement, shown in FIGS. 5B-5C as pivot line “P”. The edge, of the slots 60 serves as a fulcrum against which extensions 48 act. A manual force “F” applied to the top of back sheet 30 causes each of the inside rear-facing surfaces 64 of the plurality of extensions 48 to pivot toward the forward facing surface 65 of the auger trough 30 and toward the adhesive patch 62, which indisposed between forward facing surface 65 and rear facing surface 64. Since the back sheet 28 and auger trough 30 are limited in their relative movement due to the engagement of extensions 48 with slots 60, this rotational movement insures that the two surfaces 64, 65 make contact with each other while allowing no sliding movement of one surface 64, 65 with respect to the other surface 64, 85 (in other words, the only relative movement between the two surfaces is in a direction normal to the two surfaces).

During this rotational movement, the back sheet 28 and the auger trough 30 are relatively translated through a sequence of predetermined positions from the first relative position to the second, relative position predetermined alignment by the abutting surfaces along the pivot line “P”. When the plurality of extensions of the back sheet 28 and the auger trough 30 compress the adhesive patches between them they are in precise alignment.

Mere use of tab and slot engagement structures between the back sheet 28 and auger trough 30 will not automatically provide this ability to pivot with respect to each other and to simultaneously engage all of the adhesive patches 62 in compression (no shear) to form a bend as described in the previous 2 paragraphs. First, the engagement means must provide constrained relative rotational movement between the two sheets translating them through a sequence of predetermined positions in which they are held in careful alignment by their abutting surfaces. Second, the engagement must define a line of engagement about which the two surfaces can be relatively rotated, the advantages are significant, in the embodiment illustrated herein, a single force applied to the top of the back sheet 28 causes the simultaneous relative rotation of all of the individual extensions 48 with respect to their mating surfaces on the auger trough 30. This single force is thereby distributed to each of the adhesive patches, thereby causing one (or more) rotational forces applied to the back sheet 28 to be distributed to each of the extensions 48, which simultaneously creates each of the adhesive joints 62. This force distribution is enhanced by the provision of the transversely extending creases in the lower portion of the back sheet 28 and in the upper portion of the auger trough 30. These creases stiffen both structures right where the adhesive joints are created, which in turn distributes the force applied to the back sheet 28 more evenly to all of the adhesive joints, and provides for more consistent adhesive joints and prevent the 2 sheets from bowing with respect to each other—i.e. they keep the line of contact “P” straight. This force distribution is significant for harvester heads because of the several-meter-long line of adhesive joints that must be simultaneously created.

In the illustrated embodiment of FIGS. 5A-5C the adhesive patches 62 are initially fixed to the slotted member, here shown as the auger trough 30. In another arrangement the adhesive patches 62 may be fixed to the plurality of extensions 48 of a second member, here shown as the back sheet 28. Alternatively, the adhesive patches 62 may be initially fixed to the plurality of extensions 48 and then brought into contact with the slotted member (auger trough 30).

In an alternative arrangement (not shown), the auger trough 30 may have the plurality of extensions 48 extend upward from the free edge of the auger trough 30) and the lower edge of the back sheet 28 may have the corresponding slots configured to receive the plurality of extensions.

In another alternative arrangement (not shown), the adhesive patches 62 can be joined together in an elongate adhesive strip that extends over a substantial length of the back sheet 28 (or auger trough 60). To adhere several adjacent extensions 48 against the corresponding surfaces of auger trough 30 with which they mate. In this arrangement, an excess of adhesive material would extend between adjacent extensions 48, exposed to the elements, and would be gradually worn away during normal operation. Since this access adhesive portion between adjacent adhesive patches 62 is not adhered between 2 surfaces, its presence is unnecessary. Several of the adhesive patches 62 can be simultaneously fixed to auger trough 30 by unrolling an adhesive strip against auger trough 30 to be adhered to auger trough 30. The other side of the elongate adhesive strip can have an elongate protective layer attached that protects the adhesive on the exposed side of the elongate adhesive strip. Once this step of fixing one surface of the elongate adhesive strip against the auger trough 30 is complete, the operator can simultaneously expose the entire length of the other side of the elongate adhesive strip (the side that bonds to extensions 48) by grasping one end of the elongate protective layer and pulling it free from the entire length of the elongate adhesive strip. This has the effect of simultaneously removing the elongate protective layer from a significant portion of (even the entire length of) the entire elongate adhesive strip and hence simultaneously removing a protective layer from the plurality of the adhesive patches 62 (which, in this embodiment are merely portions of the elongate adhesive strip) with a single pull of a single elongate protective layer.

1. A harvester head (14) comprising at least first and second panels (28, 38) of sheet metal that are disposed to direct a lateral flow of cut crop material toward a feederhouse (16), and an adhesive layer (52) that fixes the first and second panels together.

2. The harvester head (14) of claim 1, in which the first and second panels (28, 30) of sheet metal are adhesively fixed together to define a laterally extending adhesive joint.

3. The harvester head (14) of claim 1, in which the first and second panels (28) of sheet metal are fixed together with an adhesively coupled tab (48) and slot (80) arrangement in which the adhesive layer (52) is comprised of a plurality of adhesive patches (62).

4. The harvester head (14) of claim 1, in which the first and second panels (28, 30) of sheet metal comprising one panel (28) with a plurality of extensions (48) that extend downward and that are engaged in a plurality of slots (60).

5. The harvester head (14) of claim 1, in which the adhesive layer (52) comprises a plurality of discrete adhesive patches (62), each said patch (62) being coupled between the first and second panels (28, 30).

6. The harvester head (14) of claim 5, in which the plurality of discrete adhesive patches (62) are spaced apart along a transversely-extending horizontal line.

7. A method of assembling two panels (28, 30) of a harvester head (14), said panels (28, 30) defining two working surfaces of the harvester head configured to direct a flow of cut crop material to a feederhouse (18), the method comprising the steps of:
inserting a plurality of tabs (48) on a first one (28) of the two panels into a plurality of corresponding slots (60) in a second one (30) of the two panels until the two panels about one another in a first relative position; and
rotating the two panels (28, 30) with respect to each other until one surface (64) of each of the plurality of tabs (48) of the first panel (28) abuts a corresponding surface (65) of the second panel.

8. The method of claim 1, further comprising the step of providing an adhesive patch (62) between each of the pairs of abutting surfaces (64, 65) of the plurality of tabs (48) and the second panel (30).

9. The method of claim 7, in which the adhesive patch (62) is a solid having opposed self-adhesive surfaces.

10. The method of claim 9, in which the adhesive patch (62) has a compressible core.

11. A back sheet (28) for a harvester head (14) having a top surface portion (42) configured to be secured to a first surface portion (40) of the harvester head (14) with a first adhesive layer (44) and a bottom surface portion (43) configured to be secured to a second surface portion (50) of the harvester head with the second adhesive layer (52).

12. The back sheet (28) of claim 11 further comprising structures (46) for holding the back sheet (28) in alignment with the first surface portion (40) while the first surface portion (40) and the top surface portion (42) are secured to each other with the first/adhesive layer (44).

13. The back sheet of claim 11, in which the bottom surface portion (43) includes alignment structures (48, 56) configured to hold the back sheet in alignment with the second surface portion (50) while the first surface portion (43) and the second surface portion (50) are secured to each other with the second adhesive layer (52).

14. The back sheet of claim 13, in which the alignment structures comprise a crease (56).

15. The back sheet of claim 13, in which the alignment structures comprise a plurality of tabs (48).

16. The back sheet of claim 14 in which the alignment structures further comprise a plurality of tabs (48) or slots formed adjacent to the crease (56).
